(19) United States
(12) Patent Application Publication
(10) Pub. No.: US 2025/0183294 A1
(43) Pub. Date: Jun. 5, 2025

(54) POSITIVE ELECTRODE ACTIVE MATERIAL FOR LITHIUM SECONDARY BATTERY AND PREPARATION METHOD THEREFOR

(71) Applicant: Beijing Easpring Material Technology Co., Ltd., Beijing (CN)

(72) Inventors: Xuequan ZHANG, Beijing (CN); Jingpeng WANG, Beijing (CN); Yanbin CHEN, Beijing (CN); Yafei LIU, Beijing (CN)

(21) Appl. No.: 19/043,981

(22) Filed: Feb. 3, 2025

Related U.S. Application Data
(63) Continuation of application No. PCT/CN2022/109897, filed on Aug. 3, 2022.

(51) Int. Cl. H01M 4/525; C01G 53/82; H01M 4/02; H01M 4/36

(52) U.S. Cl. CPC H01M 4/525; H01M 4/364; H01M 4/366; C01G 53/82; C01P 2004/03; C01P 2004/61; C01P 2006/40; H01M 2004/021; H01M 2004/028

(57) ABSTRACT

The present invention relates to a cathode active material, a method for preparing the same and a lithium secondary battery comprising the cathode active material. The cathode active material comprises agglomerated particles represented Formula Li₁₊ₐ₁Niₓ₁Co_{y1}M_{z1}M′_{1-x1-y1-z1}O₂ and single crystal particles represented by Formula Li₁₊ₐ₂Niₓ₂Co_{y2}M_{z2}M′_{1-x2-y2-z2}O₂, wherein M is one or two elements selected from Mn and Al, M′ is one or more elements selected from B, F, Mg, Si, P, Ca, Ti, V, Cr, Fe, Ga, Sr, Y, Zr, Nb, Mo, Sn, Ba, La, Ce, and W, −0.03≤a1≤0.20, 0.30≤x1≤0.99, 0≤y1≤0.30, 0≤z1≤0.30, 0≤1−x1−y1−z1≤0.10, −0.03≤a2≤0.20, 0.31≤x2≤1.00, 0≤y2≤0.30, 0≤z2≤0.30, 0≤1−x2−y2—z2≤0.10, with the proviso that: 0<x2−x1<0.5.

### CROSS-REFERENCE TO RELATED APPLICATIONS

The present application is a continuation of PCT International Patent Application No. PCT/CN2022/109897, filed Aug. 3, 2022, which is incorporated herein by reference in its entirety.

### TECHNICAL FIELD

The present invention relates to a cathode (positive electrode) active material, a method for preparing the same and a lithium secondary battery comprising the cathode active material.

### BACKGROUND ART

In recent years, with the deterioration of the energy and environment crisis, natural energy sources such as wind power and solar power have been vigorously developed. However, these energy sources have low efficiency, and are unable to make up for the shortage of the energy resources usage on a large scale. Lithium-ion batteries are green secondary batteries having prominent advantages such as high operational voltage, high energy density, good cycle life, low self-discharge, and no memory effect, and have been rapidly developed.

In the field of lithium-ion batteries, ternary layered materials (Nickel-Cobalt-Manganese, NCMs) have great potential for development due to their high specific capacity and stability. However, the stability of the material decreases gradually with the increase of the nickel content in NCMs. The reaction between the highly active Ni⁴⁺ produced during the charging process and the electrolyte will generate a NiO-like rock-salt phase, which seriously damages the structure of the layered material, causes the collapse of the cathode structure, and in turn induces the dissolution of transition metal ions, phase transformation and lattice oxygen precipitation. At present, the “secondary particles” of conventional agglomerated NCMs typically consist of many nanoscaled “primary particles”. During the charging and discharging process, the change in lattice parameters will lead to the formation of microcracks in the secondary particles. The microcracks formed will expose fresh interface inside the secondary particles, and further accelerate the degradation of the properties. It is noted that the higher the nickel content is, the more obvious the destructive effect of the cracks is. In summary, the main reason for the decrease in the cycle life of NCMs, especially high-nickel NCMs, is microcracks, which will simultaneously reduce the thermal stability, structural stability and cycle stability of the cathode material.

At present, in order to minimize the generation of microcracks in high-nickel agglomerated materials, in most studies, technologies such as coating and doping are applied to improve the strength of large particles. However, during the preparation of the batteries, it is very difficult to increase the compaction density. At the same nickel content, the capacity of small agglomerated particles is higher than that of large particles, but the properties such as the cycle life and gas production are reduced. The morphology of small single crystal particles is different from that of small agglomerated particles, and the particle strength thereof is relatively high. However, the properties such as capacity and gas production can hardly reach the desired level, and there are also major problems in screening and pulping.

Patent CN 109962221 B uses single crystal-like materials doped with agglomerate, the main ingredients of which are lithium manganese iron phosphate materials in a single crystal form and a multiple-element material in an agglomerated form. The multiple-element material and the lithium manganese iron phosphate belong to two different cathode materials with different test voltages and use ranges. Therefore, forcibly mixing the two materials together will inevitably sacrifice their respective advantages and cause waste of resources. As disclosed in Patent No. CN 107154491 B, two materials with different conductivities are mixed together, although the capacities of the two materials are considered respectively, the effect of the Ni content of the two different materials on the final product is not taken into account. Since the two materials are mixed together, the claimed range for the particle size is also relatively wide and the effect on the final product can hardly be determined.

### SUMMARY OF THE INVENTION

An object of the present invention is to overcome the shortcomings in the prior art and effectively enhance the deficiencies of the blended product such as low capacity and poor cycle life. The present invention effectively improves the capacity of the cathode active material by rendering the Ni content in small particles higher than the Ni content in large particles. In addition, by preparing large agglomerated particles and small single crystal particles and controlling their different surface characteristics, the generation of microcracks in the large agglomerated particles can be effectively inhibited, so as to improve the stability of the cathode active material during long-term cycles. The cathode active material provided by the present invention has properties such as high compaction density, high capacity and high stability.

In one aspect, the present invention provides a cathode active material for lithium secondary battery, wherein the cathode active material comprises agglomerated particles represented by Formula A1 and single crystal particles represented by Formula A2

Li₁₊ₐ₁Niₓ₁Co_{y1}M_{z1}M′_{1-x1-y1-z1}O₂ A1

Li₁₊ₐ₂Niₓ₂Co_{y2}M_{z2}M′_{1-x2-y2-z2}O₂ A2
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W,
−0.03≤a1≤0.20, 0.30≤x1≤0.99, 0≤y1≤0.30, 0≤z1≤0.30, 0≤1−x1−y1−z1≤0.10, −0.03≤a2≤0.20, 0.31≤x2≤1.00, 0≤y2≤0.30, 0≤z2≤0.30, 0≤1−x2−y2—z2≤0.10, with the proviso that: 0<x2−x1<0.5.

In another aspect, the present invention also provides a method for preparing a cathode active material, including the steps of:
i) preparing an agglomerated particle precursor represented by Formula A3 and a single crystal particle precursor represented by Formula A4 separately by a liquid-phase co-precipitation process

Niₓ₁Co_{y1}M_{z1}M′_{1-x1-y1-z1}(OH)₂ A3

Niₓ₂Co_{y2}M_{z2}M′_{1-x2-y2-z2}(OH)₂ A4
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W,
0.30≤x1≤0.99, 0≤y1≤0.30, 0≤z1≤0.30, 0≤1−x1−y1−z1≤0.10, 0.31≤x2≤1.00, 0≤y2≤0.30, 0≤z2≤0.30, 0≤1−x2−y2−z2≤0.10, with the proviso that: 0<x2−x1≤0.5;
ii) mixing a lithium source with the agglomerated particle precursor at a molar ratio of r1, and optionally incorporating M′ as a doping element, wherein 0.97≤r1≤1.20; then performing a primary sintering at the sintering temperature T1 in a sintering atmosphere of air or oxygen, wherein 600° C.≤T1≤1000° C.; and then obtaining agglomerated particles via crushing;
iii) mixing a lithium source with the single crystal particle precursor at a molar ratio of r2, and optionally incorporating M′ as a doping element, wherein 0.97≤r2≤1.20; then performing a primary sintering at the sintering temperature T2 in a sintering atmosphere of air or oxygen, wherein 650° C.≤T2≤1050° C.; and then obtaining single crystal particles via crushing; and
iv) blending the agglomerated particles of Step ii) with the single crystal particles of Step iii) to obtain the cathode active material.

In still another aspect, the present invention also provides a lithium secondary battery comprising the cathode active material according to the present invention or the cathode active material prepared by the preparation method according to the present invention.

### BRIEF DESCRIPTION OF THE DRAWINGS

FIGS. 1 to 3 show SEM photographs for the large agglomerated particles A1 and the small single crystal particles A2 in Example 1 as well as the SEM photograph for the blend of the above two particles, respectively;

FIG. 4 shows the charge-discharge curves of Example 1, Comparative Example 1, and Comparative Example 2; and

FIG. 5 shows the cycle life of Example 1, Comparative Example 1, and Comparative Example 2.

### DETAILED DESCRIPTION

Unless otherwise indicated, all publications, patent applications, patents, and other references mentioned herein are expressly incorporated by reference in their entirety for all purposes as if they are fully set forth.

Unless otherwise defined, all technical and scientific terms used herein have the same meaning as commonly understood by those ordinary skilled in the art to which the present invention belongs. In the event of a conflict, the present description, including definitions, shall prevail.

If quantities, concentrations, or other values or parameters are given as a range, a preferred range, or a series of preferred upper limit and preferred lower limits, it should be understood that all ranges formed by combination of the upper limit or a preferred value of/in any range with the lower limit or preferred value or a preferred value of/in the range are specifically disclosed, regardless whether these ranges are separately disclosed or not. When a numerical range is mentioned, unless otherwise indicated, the range includes its endpoints and all integers and fractions within the range.

In one aspect, the present invention provides a cathode active material for lithium secondary battery, wherein the cathode active material comprises agglomerated particles represented by Formula A1 and single crystal particles represented by Formula A2

Li₁₊ₐ₁Niₓ₁Co_{y1}M_{z1}M′_{1-x1-y1-z1}O₂ A1

Li₁₊ₐ₂Niₓ₂Co_{y2}M_{z2}M′_{1-x2-y2-z2}O₂ A2
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W, −0.03≤a1≤0.20, preferably −0.01≤a1≤0.14, more preferably 0≤a1≤0.10, and particularly preferably 0.01≤a1≤0.08,
0.30≤x1≤0.99, preferably 0.57≤x1≤0.99, more preferably 0.72≤x1≤0.99, and particularly preferably 0.80≤x1≤0.99,
0≤y1≤0.30, preferably 0≤y1≤0.21, more preferably 0≤y1≤0.15, and particularly preferably 0≤y1≤0.10,
0≤z1≤0.30, preferably 0≤z1≤0.18, more preferably 0≤z1≤0.11, and particularly preferably 0≤z1≤0.06,
0≤1−x1−y1−z1≤0.10, preferably 0≤1−x1−y1−z1≤0.08, more preferably 0≤1−x1−y1−z1≤0.05, and particularly preferably 0≤1−x1−y1−z1≤0.03,
−0.03≤a2≤0.20, preferably −0.02≤a2≤0.16, more preferably −0.01≤a2≤0.14, and particularly preferably 0≤a2≤0.08,
0.31≤x2≤1.00, preferably 0.59≤x2≤0.995, more preferably 0.75≤x2≤0.995,and particularly preferably 0.81≤x2≤0.995,
0≤y2≤0.30, preferably 0≤y2≤0.21, more preferably 0≤y2≤0.15, and particularly preferably 0≤y2≤0.10,
0≤z2≤0.30, preferably 0≤z2≤0.18, more preferably 0≤z2≤0.11, and particularly preferably 0≤z2≤0.08,
0≤1−x2−y2−z2≤0.10, preferably 0≤1−x2−y2−z2≤0.08, more preferably 0≤1−x2−y2−z2≤0.05, and particularly preferably 0≤1−x2−y2−z2≤0.03,
with the proviso that: 0<x2−x1≤0.5, preferably 0.01≤x2−x1≤0.27, more preferably 0.01≤x2−x1≤0.2, further preferably 0.015≤x2−x1≤0.20, and particularly preferably 0.02≤x2−x1≤0.15.

According to one embodiment of the cathode active material of the present invention, a2>a1, preferably 0.01≤a2−a1≤0.20, more preferably 0.01≤a2−a1≤0.12, and particularly preferably 0.01≤a2−a1≤0.07, especially preferably 0.01≤a2−a1≤0.04.

According to another embodiment of the cathode active material of the present invention, the agglomerated particles have a particle size D₅₀ of 6 to 30 μm, preferably 8 to 25 μm, more preferably 9 to 20 μm, and particularly preferably 10 to 18 μm.

According to another embodiment of the cathode active material of the present invention, the single crystal particles have a particle size D₅₀ of 0.1 to 10 μm, preferably 0.5 to 8.0 μm, more preferably 1.0 to 6.0 μm, and particularly preferably 1.5 to 4.5 μm.

According to another embodiment of the cathode active material of the present invention, the agglomerated particles are present in an amount of 20 to 90%, preferably 45 to 85%, more preferably 50 to 80%, and particularly preferably 60 to 80%, the single crystal particles are present in an amount of 10 to 80%, preferably 10 to 70%, more preferably 15 to 60%, and particularly preferably 20 to 40%, based on the weight of the cathode active material.

According to another embodiment of the cathode active material of the present invention, the agglomerated particles have a coating layer containing at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, wherein the coating element is present in an amount of 0.1 to 2 mol %, and preferably about 1 mol %, based on the agglomerated particles; and/or, the single crystal particles have a coating layer containing at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, wherein the coating element is present in an amount of 0.1 to 2 mol %, and preferably about 1 mol %, based on the single crystal particles; with the proviso that: the coating element contained in the coating layer of the agglomerated particles is different from the coating element contained in the coating layer of the single crystal particles.

According to another embodiment of the cathode active material of the present invention, the cathode active material has specific surface areas BETbefore and BETafter before and after sintering at 600° C. in an air atmosphere for 8 hours, which satisfy:
preferably,

$$\vert {BET}_{after} - {BET}_{before} \vert / {BET}_{before} \leq 50 \% ,$$

$$\vert {BET}_{after} - B E {T}_{before} \vert / {BET}_{before} \leq 30 \% .$$

The present invention uses single crystal particles with rounded surfaces and agglomerated particles with high particle strength, in combination with an optimal blending ratio, the controlled finished material exhibits a stable crystal structure, thereby reducing the change in surface porosity of the finished product during further sintering.

According to another embodiment of the cathode active material of the present invention, the agglomerated particles have specific surface areas BET_{before} and BET_{after} before and after sintering at 600° C. in an air atmosphere for 8 hours, which satisfy:
preferably,

$$( {BET}_{after} - {BET}_{before} ) / {BET}_{before} \geq 15 \% ,$$

$$40 \% \geq ( {BET}_{after} - {BET}_{before} ) / {BET}_{before} \geq 20 \% .$$

Agglomerated particles consist of many nanoscaled particles. In order to maintain good cycle performance, the surface of the nanoparticles should not have excessive voids, and the BET of the material is required to be controlled within a certain range. Under normal circumstances, after sintering at a high temperature, the BET of the material will further decrease. However, by controlling the crystallinity and orientation of the nano-grains on the surface of the material, in combination with in-situ melting surface treatment, a good surface/interface protection effect can be achieved according to the present invention. Moreover, it is unexpectedly found that the BET of the material surface does not decrease, but increases. The inventors further found that after the agglomerated particles with such surface BET property are blended with single crystal particles, the cathode material exhibits relatively excellent compression-resistant property, better discharge capacity and cycle performance.

According to another embodiment of the cathode active material of the present invention, the single crystal particles have specific surface areas BET_{before} and BET_{after} before and after sintering at 600° C. in an air atmosphere for 8 hours, which satisfy:
preferably,

$$( {BET}_{before} - {BET}_{after} ) / {BET}_{before} \leq 15 \% ,$$

$$0 \leq ( {BET}_{before} - {BET}_{after} ) / {BET}_{before} \leq 10 \% .$$

Since the single crystal particles of the present invention have properties such as good crystallinity and rounded surface, they are relatively stable in structure. During the high-temperature sintering, the material does not collapse or close to a large extent, and has less change in BET as compared with the BET of the un-sintered material.

According to another embodiment of the cathode active material of the present invention, the cathode active material does not comprise nickel-free active materials, such as lithium manganese iron phosphate.

According to another embodiment of the cathode active material of the present invention, the cathode active material consists of the agglomerated particles represented by Formula A1 and the single crystal particles represented by Formula A2.

In another aspect, the present invention further provides a method for preparing a cathode active material, including the steps of:
i) preparing an agglomerated particle precursor represented by Formula A3 and a single crystal particle precursor represented by Formula A4 separately by a liquid-phase co-precipitation process

Niₓ₁Co_{y1}M_{z1}M′_{1-x1-y1-z1}(OH)₂ A3

Niₓ₂Co_{y2}M_{z2}M′_{1-x2-y2-z2}(OH)₂ A4
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W,
0.30≤x1≤0.99, preferably 0.57≤x1≤0.99, more preferably 0.72≤x1≤0.99, and particularly preferably 0.80≤x1≤0.99,
0≤y1≤0.30, preferably 0≤y1≤0.21, more preferably 0≤y1≤0.15, and particularly preferably 0≤y1≤0.10,
0≤z1≤0.30, preferably 0≤z1≤0.18, more preferably 0≤z1≤0.11, and particularly preferably 0≤z1≤0.06,
0≤1−x1−y1−z1≤0.10, preferably 0≤1−x1−y1−z1≤0.08, more preferably 0≤1−x1−y1−z1≤0.05, and particularly preferably 0≤1−x1−y1−z1≤0.03,
0.31≤x2≤1.00, preferably 0.59≤x2≤0.995, more preferably 0.75≤x2≤0.995, and particularly preferably 0.81≤x2≤0.995,
0≤y2≤0.30, preferably 0≤y2≤0.21, more preferably 0≤y2≤0.15, and particularly preferably 0≤y2≤0.10,
0≤z2≤0.30, preferably 0≤z2≤0.18, more preferably 0≤z2≤0.11, and particularly preferably 0≤z2≤0.08,
0≤1−x2−y2−z2≤0.10, preferably 0≤1−x2−y2−z2≤0.08, more preferably 0≤1−x2−y2−z2≤0.05, and particularly preferably 0≤1−x2−y2−z2≤0.03,
with the proviso that: 0<x2−x1≤0.5, preferably 0.01≤x2−x1≤0.27, more preferably 0.01≤x2−x1≤0.20, further preferably 0.015≤x2−x1≤0.20, and particularly preferably 0.02≤x2−x1≤0.15;
ii) mixing a lithium source with the agglomerated particle precursor at a molar ratio of r1, and optionally incorporating M′ as a doping element, wherein 0.97≤r1≤1.20, preferably 0.99≤r1≤1.14, more preferably 1.00≤r1≤1.10, and particularly preferably 1.01≤r1≤1.08; then performing a primary sintering at the sintering temperature T1 in a sintering atmosphere of air or oxygen, preferably oxygen, wherein 600° C.≤T1≤1000° C., preferably 675° C.≤T1≤875° C., more preferably 690° C.≤T1≤800° C., and particularly preferably 690° C.≤T1≤780° C.; and then obtaining agglomerated particles via crushing;
iii) mixing a lithium source with the single crystal particle precursor at a molar ratio of r2, and optionally incorporating M′ as a doping element, wherein 0.97≤r2≤1.20, preferably 0.98≤r2≤1.16, more preferably 0.99≤r2≤1.14, and particularly preferably 1.00≤r2≤1.08; then performing a primary sintering at the sintering temperature T2 in a sintering atmosphere of air or oxygen, preferably oxygen, wherein 650° C.≤T2≤1050° C., preferably 730° C.≤T2≤930° C., more preferably 750° C.≤T2≤930° C., and particularly preferably 750° C.≤T2≤900° C.; and then obtaining single crystal particles via crushing; and
iv) blending the agglomerated particles of Step ii) with the single crystal particles of Step iii) to obtain the cathode active material.

According to another embodiment of the method according to the present invention, r2>r1, preferably 0.01≤r2−r1≤0.20, more preferably 0.01≤r2−r1≤0.12, particularly preferably 0.01≤r2−r1≤0.07, and especially preferably 0.01≤r2−r1≤0.04.

According to another embodiment of the method according to the present invention, the agglomerated particle precursor has a particle size D₅₀ of 6.5 to 30.5 μm, preferably 8.5 to 25.5 μm, more preferably 9.5 to 20.5 μm, and particularly preferably 10.5 to 18.5 μm. The agglomerated particles have a particle size D50 of 6 to 30 μm, preferably 8 to 25 μm, more preferably 9 to 20 μm, and particularly preferably 10 to 18 μm.

According to another embodiment of the method according to the present invention, the single crystal particle precursor has a particle size D₅₀ of 0.1 to 30.5 μm, preferably 1.0 to 17.3 μm, more preferably 1.0 to 9.3 μm, and particularly preferably 1.0 to 6.0 μm. The single crystal particles have a particle size D50 of 0.1 to 10 μm, preferably 0.5 to 8.0 μm, more preferably 1.0 to 6.0 μm, and particularly preferably 1.5 to 4.5 μm.

According to another embodiment of the method according to the present invention, the agglomerated particles are present in an amount of 20 to 90%, preferably 45 to 85%, more preferably 50 to 80%, and particularly preferably 60 to 80%, the single crystal particles are present in an amount of 10 to 80%, preferably 10 to 70%, more preferably 15 to 60%, and particularly preferably 20 to 40%, based on the weight of the cathode active material.

According to another embodiment of the method according to the present invention, prior to Step iv), the agglomerated particles are mixed with a coating precursor comprising at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, and then a secondary sintering is performed at the sintering temperature T3 in a sintering atmosphere of air or oxygen, preferably oxygen, to obtain secondarily sintered agglomerated particles, wherein 250° C.≤T3≤800° C., preferably 250° C.≤T3≤600° C., more preferably 250° C.≤T3≤480° C., and particularly preferably 250° C.≤T3≤450° C., wherein the coating element is present in an amount of 0.1 to 2 mol %, preferably about 1 mol %, based on the agglomerated particles; and/or, in addition, the single crystal particles are mixed with a coating precursor comprising at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, and then a secondary sintering is performed at the sintering temperature T4 in a sintering atmosphere of air or oxygen, preferably oxygen, to obtain secondarily sintered single crystal particles, wherein 300° C.≤T4≤900° C., preferably 460° C.≤T4≤800° C., more preferably 550° C.≤T4≤750° C., and particularly preferably 600° C.≤T4≤750° C., wherein the coating element is present in an amount of 0.1 to 2 mol %, preferably about 1 mol %, based on the single crystal particles; with the proviso that: the coating element contained in the coating precursor of the agglomerated particles is different from the coating element contained in the coating precursor of the single crystal particles.

In another aspect, the present invention further provides a lithium secondary battery comprising the cathode active material according to the present invention or the cathode active material prepared by the preparation method according to the present invention.

### EXAMPLES

### Example 1

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

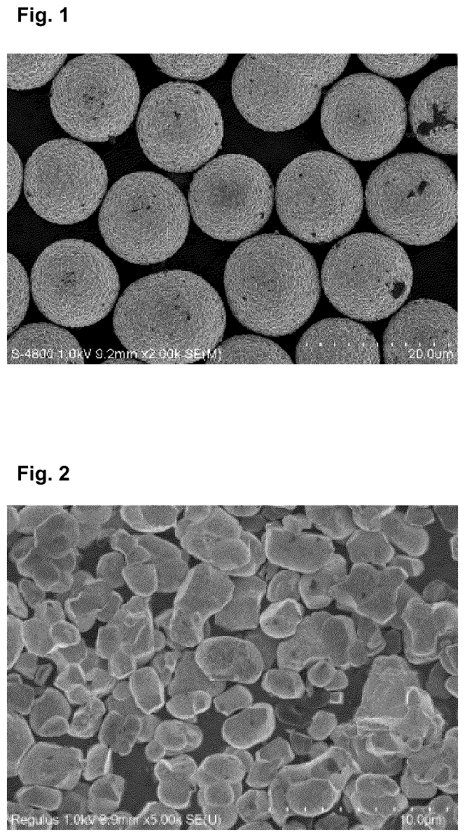

LiOH and Ni_{0.83}Co_{0.11} Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 1 mol % of B, and sintered for the second time at a sintering temperature of 400° C. to obtain a large agglomerated particle material with a D₅₀ of 10.0 μm, as shown in FIG. 1. The agglomerated material was treated at 600° C. for 8 hours, and had a BET increased by a change rate of 35%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm, as shown in FIG. 2. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery, as shown in FIG. 3. The cathode active material was treated at 600° C. for 8 hours, and had a BET increased by a change rate of 24%.

### Example 2

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

LiOH and Ni_{0.83}Co_{0.11}Mn_{0.06}(OH)₂ were mixed at a molar ratio of 1.06. The mixed material was sintered for the first time in an oxygen atmosphere at a sintering temperature of 745° C. The sintered material was crushed, and the crushed material was added with boric acid containing 0.8 mol % of B, and sintered for the second time at a sintering temperature of 380° C. to obtain a large agglomerated particle material with a D₅₀ of 10.0 μm. The agglomerated material was treated at 600° C. for 8 hours, and had a BET increased by a change rate of 24%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with Al₂O₃ containing 1.2 mol % of Al, and sintered for the second time at a sintering temperature of 610° C. to obtain a small single crystal particle material with a D₅₀ of 3.5 μm. The single crystal material was treated at 600° C. for 8 hours, and had a BET decreased by a change rate of 3%.

The above-mentioned large agglomerated particles and small single crystal particles were mixed in a mass ratio of 8:2 to obtain a cathode active material for lithium secondary battery. The cathode active material was treated at 600° C. for 8 hours, and had a BET increased by a change rate of 19%.

### Example 3

Firstly, an agglomerated cathode precursor (10.5 μm) having a composition of Ni_{0.86}Co_{0.11}Mn_{0.03}(OH)₂ and a single crystal cathode precursor (4 μm) having a composition of Ni_{0.88}Co_{0.08}Mn_{0.04}(OH)₂ were separately prepared by a liquid-phase co-precipitation process.

LiOH and Ni_{0.86}Co_{0.11}Mn_{0.03}(OH)₂ were mixed at a molar ratio of 1.06. The mixed material was sintered for the first time in an oxygen atmosphere at a sintering temperature of 725° C. The sintered material was crushed, and the crushed material was added with boric acid containing 0.8 mol % of B, and sintered for the second time at a sintering temperature of 380° C. to obtain a large agglomerated particle material with a D₅₀ of 10.0 μm. The agglomerated material was treated at 600° C. for 8 hours, and had a BET increased by a change rate of 26%.

LiOH and Ni_{0.88}Co_{0.08}Mn_{0.04}(OH)₂ were mixed at a molar ratio of 1.11. The mixed material was sintered for the first time in an oxygen atmosphere at a sintering temperature of 805° C. The sintered material was crushed, and the crushed material was added with Al₂O₃ containing 1.0 mol % of Al, and sintered for the second time at a sintering temperature of 610° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 20%.

### Example 4

Firstly, an agglomerated cathode precursor (10.5 μm) having a composition of Ni_{0.86}Co_{0.11}Mn_{0.03}(OH)₂ and a single crystal cathode precursor (4 μm) having a composition of Ni_{0.88}Co_{0.08}Mn_{0.04}(OH)₂ were separately prepared by a liquid-phase co-precipitation process.

LiOH and Ni_{0.86}Co_{0.11}Mn_{0.03}(OH)₂ were mixed at a molar ratio of 1.06. The mixed material was sintered for the first time in an oxygen atmosphere at a sintering temperature of 685° C. The sintered material was crushed, and the crushed material was added with boric acid containing 0.8 mol % of B, and sintered for the second time at a sintering temperature of 380° C. to obtain a large agglomerated particle material with a D₅₀ of 10.0 μm. The agglomerated material was treated at 600° C. for 8 hours, and had a BET increased by a change rate of 26%.

LiOH and Ni_{0.88}Co_{0.08}Mn_{0.04}(OH)₂ were mixed at a molar ratio of 1.11. The mixed material was sintered for the first time in an oxygen atmosphere at a sintering temperature of 805° C. The sintered material was crushed, and the crushed material was added with Al₂O₃ containing 1.0 mol % of Al, and sintered for the second time at a sintering temperature of 610° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 3:7 to obtain a cathode active material for lithium secondary battery. The cathode active material was treated at 600° C. for 8 hours, and had a BET increased by a change rate of 6%.

### Example 5

Firstly, an agglomerated cathode precursor (10.5 μm) having a composition of Ni_{0.88}Co_{0.10}Mn_{0.02}(OH)₂ and a single crystal cathode precursor (4 μm) having a composition of Ni_{0.90}Co_{0.08}Mn_{0.02}(OH)₂ were separately prepared by a liquid-phase co-precipitation process.

LiOH and Ni_{0.88}Co_{0.10}Mn_{0.02}(OH)₂ were mixed at a molar ratio of 1.08. The mixed material was sintered for the first time in an oxygen atmosphere at a sintering temperature of 780° C. The sintered material was crushed, and the crushed material was added with boric acid containing 1 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 32%.

LiOH and Ni_{0.90}Co_{0.08}Mn_{0.02}(OH)₂ were mixed at a molar ratio of 1.12. The mixed material was sintered for the first time in an oxygen atmosphere at a sintering temperature of 812° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 22%.

### Example 6

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

LiOH and Ni_{0.83}Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 1 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 35%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with boric acid containing 0.4 mol % of B, and sintered for the second time at a sintering temperature of 400° C. to obtain a small single crystal particle material with a D₅₀ of 3.5 μm. The single crystal material was treated at 600° C. for 8 hours, and had a BET increased by a change rate of 9%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 27%.

### Example 7

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

LiOH and Ni_{0.83} Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 0.5 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 11%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 7%.

### Example 8

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

LiOH and Ni_{0.83}Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with Al₂O₃ containing 1 mol % of Al, and sintered for the second time at a sintering temperature of 620° C. to obtain a large agglomerated particle material with a D₅₀ of 10.0 μm. The agglomerated material was treated at 600° C. for 8 hours, and had a BET decreased by a change rate of 3%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET decreased by a change rate of 3%.

### Example 9

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.86}Co_{0.08}Mn_{0.06}(OH)₂ were separately prepared by a liquid-phase co-precipitation process.

LiOH and Ni_{0.83} Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 0.5 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 11%.

LiOH and Ni_{0.86}Co_{0.08}Mn_{0.06}(OH)₂ were mixed at a molar ratio of 1.12. The mixed material was sintered for the first time in an oxygen atmosphere at a sintering temperature of 812° C. The sintered material was crushed, and the crushed material was added with boric acid containing 0.4 mol % of B, and sintered for the second time at a sintering temperature of 400° C. to obtain a small single crystal particle material with a D₅₀ of 3.5 μm. The single crystal material was treated at 600° C. for 8 hours, and had a BET increased by a change rate of 9%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 10%.

### Example 10

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.84}Co_{0.08}Mn_{0.08}(OH)₂ were separately prepared by a liquid-phase co-precipitation process.

LiOH and Ni_{0.83} Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 0.5 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 35%.

LiOH and Ni_{0.84}Co_{0.08}Mn_{0.08}(OH)₂ were mixed at a molar ratio of 1.12. The mixed material was sintered for the first time in an oxygen atmosphere at a sintering temperature of 812° C. The sintered material was crushed, and the crushed material was added with boric acid containing 0.4 mol % of B, and sintered for the second time at a sintering temperature of 400° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 24%.

### Comparative Example 1

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.80}Co_{0.11}Mn_{0.09}(OH)₂ were separately prepared by a liquid-phase co-precipitation process.

LiOH and Ni_{0.83}Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 1 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 35%.

LiOH and Ni_{0.80}Co_{0.11}Mn_{0.09}(OH)₂ were mixed at a molar ratio of 1.12. The mixed material was sintered for the first time in an oxygen atmosphere at a sintering temperature of 820° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 25%.

### Comparative Example 2

Firstly, an agglomerated cathode precursor (10.5 μm) having a composition of Ni_{0.83}Co_{0.11}Mn_{0.06}(OH)₂ and a single crystal cathode precursor (4 μm) having a composition of Ni_{0.83}Co_{0.11}Mn_{0.06}(OH)₂ were separately prepared by a liquid-phase co-precipitation process.

LiOH and Ni_{0.83}Co_{0.11}Mn_{0.06}(OH)₂ were mixed at a molar ratio of 1.08. The mixed material was sintered for the first time in an oxygen atmosphere at a sintering temperature of 750° C. The sintered material was crushed, and the crushed material was added with boric acid containing 1 mol % of B, and sintered for the second time at a sintering temperature of 400° C. to obtain a large agglomerated particle material with a D₅₀ of 10.0 μm. The agglomerated material was treated at 600° C. for 8 hours, and had a BET increased by a change rate of 35%.

LiOH and Ni_{0.83}Co_{0.11}Mn_{0.06}(OH)₂ were mixed at a molar ratio of 1.12. The mixed material was sintered for the first time in an oxygen atmosphere at a sintering temperature of 816° C. The sintered material was crushed, and the crushed material was added with Al₂O₃ containing 1 mol % of Al, and sintered for the second time at a sintering temperature of 620° C. to obtain a small single crystal particle material with a D₅₀ of 3.5 μm. The single crystal material was treated at 600° C. for 8 hours, and had a BET decreased by a change rate of 2%.

The above-mentioned large agglomerated particles and small single crystal particles were mixed in a mass ratio of 7:3 to obtain a cathode active material for lithium secondary battery. The cathode active material was treated at 600° C. for 8 hours, and had a BET increased by a change rate of 25%.

### Specific Surface Area Test:

Tri-star 3020 Specific Surface Area Analyzer was used for the test. 3 g of sample was weighed. A sample tube was installed on the vacuum joint at the port of a degassing station. The heating temperature was set at 300° C., and the degassing time was set as 120 minutes. After degassing, the sample tube was cooled. The mass of the empty sample tube and the mass of the sample and the sample tube after degassing were input through the software interface of the analyzer. The specific surface area data (BET method) calculated and output by the software was recorded, and the specific surface area test for the cathode material sample was completed.

### Particle Size Test:

Mastersizer 2000 Laser Particle Size Analyzer was used for the test. The following modifications were made to the item of “Measurement” in the software: both “Sample Measurement Time” and “Background Measurement Time” in the item of “Measurement Times” were set to 6 seconds. “Repeat Times” were set to 3 times, and “Delay Time” was set to 5 seconds in the item of “Repeat Measurement”. “Generate Average Result Record from Measurements” was clicked. Next, “Start” was clicked to automatically measure the background. After the automatic measurement was completed, 40 ml of sodium pyrophosphate was initially added, and a small amount of sample was then added by a spatula. “Start” was clicked until the obscuration reached ½ of the visually perceived range between 10 to 20%. Finally, the three results and the average value thereof were recorded.

### Preparation of Button-type Battery

Firstly, a composite nickel-cobalt-manganese multi-element cathode active material for non-aqueous electrolyte secondary batteries, acetylene black and polyvinylidene fluoride (PVDF) were mixed and coated on an aluminum foil, and dried in an oven. The dried cathode sheet, separator, anode sheet and electrolyte were assembled into a 2025 Type button-type battery in an Ar-filled glove box having both the moisture content and the oxygen content of less than 5 ppm.

### Method for Measuring the Initial Discharge Capacity:

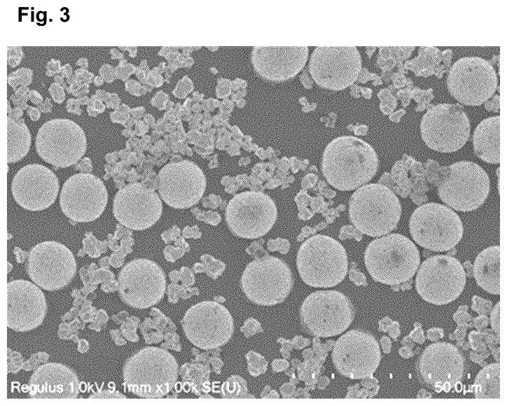

The button-type battery was placed for 2 hours after fabrication. After the open circuit voltage was stabilized, the cathode was charged to a cut-off voltage of 4.3V at a current density of 0.1C, then charged at a constant voltage for 30 minutes, and subsequently discharged to a cut-off voltage of 3.0 V at the same current density; this process was performed one more time in the same manner, and the discharge capacity was regarded as the initial discharge capacity. FIG. 4 shows the charge-discharge curves of the button-type batteries prepared from the cathode materials in Example 1, and Comparative Examples 1 and 2. It can be seen that the cathode material in Example 1 has a higher initial discharge capacity as compared with that in the Comparative Examples.

### Preparation of Full Battery and Gas Production Test:

A cathode material Lithium Nickel Cobalt Manganese Oxide, an anode material graphite, a conductive agent carbon black, and a binder PVDF were dried in a vacuum oven at 120° C. for 12 hours. The oven-dried cathode material, conductive agent carbon black, PVDF, and NMP were mixed uniformly to prepare a cathode slurry. The slurry was coated on an aluminum foil by a coater for lithium batteries, and dried. The electrode sheet was cut by an electrode sheet cutter, and rolled by an electrode sheet roller.

950 g of dried artificial graphite, 13 g of Super-P, 14 g of CMC, 46 g of SBR solution and 1200 g of deionized water were mixed uniformly to prepare an anode slurry. The slurry was coated on a copper foil by a coater for lithium batteries, and dried. The anode sheet obtained after coating was dried in a vacuum oven, cut by an electrode sheet cutter, and rolled by an electrode sheet roller.

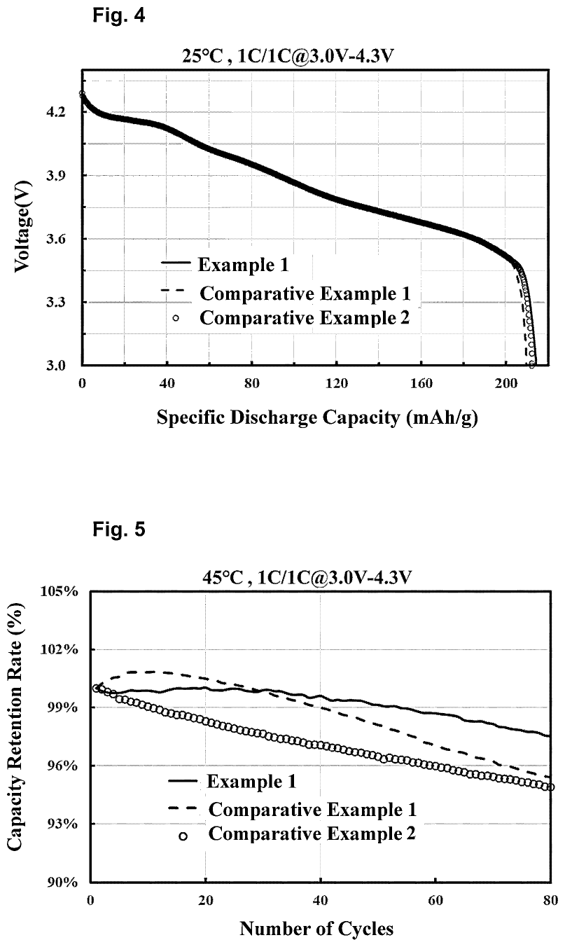

The above-mentioned cathode sheet and anode sheet were wound by a conventional preparation method, and an electrolyte was injected to make a full battery. The initial thickness of the full battery after formation was measured, stored in a constant-temperature cabinet at 45° C. for 7 days, and then the thickness of the full battery was measured again. The increase rate of the thickness was used to characterize the gas production of the cathode material in the full battery. FIG. 5 shows the change in cycle life for the full batteries prepared from the cathode materials in Example 1, Comparative Examples 1 and 2. It can be seen that the full battery prepared from the cathode material in Example 1 shows a better stability and a longer cycle life.

| | | | | | | | Change in | | | | |
|---|---|---|---|---|---|---|---|---|---|---|---|
| | | | | Blending | | Change in | BET of | | | | |
| | | | | Ratio of | | BET of | single | | Initial | | |
| | Type of | Ni | | large to small | Change in | agglomerated | crystal | Compaction | Charge | Cycle | Gas Pro- |
| | Particles | Content | D₅₀ | particles | BET | particles | particles | Density | Capacity | Life | duction |
| | / | mol % | μm | / | % | % | % | g/cm³ | mAh/g | % | % |
| Exam- | large | 83 | 10 | 7:3 | increased | increased | decreased | 3.55 | 214.3 | 97.4 | 7.2 |
| ple 1 | agglomerated | | | | by 24 | by 35 | by 2 | | | | |
| | particles | | | | | | | | | | |
| | small single | 86 | 3.5 | | | | | | | | |
| | crystal | | | | | | | | | | |
| | particles | | | | | | | | | | |
| Exam- | large | 83 | 10 | 8:2 | increased | increased | decreased | 3.48 | 215.2 | 97.0 | 8.5 |
| ple 2 | agglomerated | | | | by 19 | by 24 | by 3 | | | | |
| | particles | | | | | | | | | | |
| | small single | 86 | 3.5 | | | | | | | | |
| | crystal | | | | | | | | | | |
| | particles | | | | | | | | | | |
| Exam- | large | 86 | 10 | 7:3 | increased | increased | decreased | 3.56 | 216.7 | 96.9 | 9.3 |
| ple 3 | agglomerated | | | | by 20 | by 26 | by 2 | | | | |
| | particles | | | | | | | | | | |
| | small single | 88 | 3.5 | | | | | | | | |
| | crystal | | | | | | | | | | |
| | particles | | | | | | | | | | |
| Exam- | large | 86 | 10 | 3:7 | increased | increased | decreased | 3.67 | 215.6 | 96.5 | 6.4 |
| ple 4 | agglomerated | | | | by 6 | by 26 | by 2 | | | | |
| | particles | | | | | | | | | | |
| | small single | 88 | 3.5 | | | | | | | | |
| | crystal | | | | | | | | | | |
| | particles | | | | | | | | | | |
| Exam- | large | 88 | 10 | 7:3 | increased | increased | decreased | 3.58 | 217.5 | 97.3 | 10.6 |
| ple 5 | agglomerated | | | | by 22 | by 32 | by 2 | | | | |
| | particles | | | | | | | | | | |
| | small single | 90 | 3.5 | | | | | | | | |
| | crystal | | | | | | | | | | |
| | particles | | | | | | | | | | |
| Exam- | large | 83 | 10 | 7:3 | increased | increased | increased | 3.61 | 215.0 | 94.3 | 12.7 |
| ple 6 | agglomerated | | | | by 27 | by 35 | by 9 | | | | |
| | particles | | | | | | | | | | |
| | small single | 86 | 3.5 | | | | | | | | |
| | crystal | | | | | | | | | | |
| | particles | | | | | | | | | | |
| Exam- | large | 83 | 10 | 7:3 | increased | increased | decreased | 3.60 | 214.5 | 95.6 | 11.4 |
| ple 7 | agglomerated | | | | by 7 | by 11 | by 2 | | | | |
| | particles | | | | | | | | | | |
| | small single | 86 | 3.5 | | | | | | | | |
| | crystal | | | | | | | | | | |
| | particles | | | | | | | | | | |
| Exam- | large | 83 | 10 | 7:3 | decreased | decreased | decreased | 3.57 | 214.2 | 93.3 | 10.3 |
| ple 8 | agglomerated | | | | by 3 | by 3 | by 2 | | | | |
| | particles | | | | | | | | | | |
| | small single | 86 | 3.5 | | | | | | | | |
| | crystal | | | | | | | | | | |
| | particles | | | | | | | | | | |
| Exam- | large | 83 | 10 | 7:3 | increased | increased | increased | 3.62 | 213.5 | 94.4 | 11.6 |
| ple 9 | agglomerated | | | | by 10 | by 11 | by 9 | | | | |
| | particles | | | | | | | | | | |
| | small single | 86 | 3.5 | | | | | | | | |
| | crystal | | | | | | | | | | |
| | particles | | | | | | | | | | |
| Exam- | large | 83 | 10 | 7:3 | increased | increased | decreased | 3.55 | 212.8 | 95.3 | 8.9 |
| ple 10 | agglomerated | | | | by 24 | by 35 | by 2 | | | | |
| | particles | | | | | | | | | | |
| | small single | 84 | 3.5 | | | | | | | | |
| | crystal | | | | | | | | | | |
| | particles | | | | | | | | | | |
| Compar- | large | 83 | 10 | 7:3 | increased | increased | decreased | 3.53 | 209.7 | 95.2 | 7.6 |
| ative | agglomerated | | | | by 25 | by 35 | by 2 | | | | |
| Example 1 | particles | | | | | | | | | | |
| | small single | 80 | 3.5 | | | | | | | | |
| | crystal | | | | | | | | | | |
| | particles | | | | | | | | | | |
| Compar- | large | 83 | 10 | 7:3 | increased | increased | decreased | 3.47 | 212.3 | 94.8 | 10.7 |
| ative | agglomerated | | | | by 25 | by 35 | by 2 | | | | |
| Example 2 | particles | | | | | | | | | | |
| | small single | 83 | 3.5 | | | | | | | | |
| | crystal | | | | | | | | | | |
| | particles | | | | | | | | | | |

The cathode active material and the lithium ion battery thereof provided by the present invention achieve the following beneficial effects:
1) As compared with the agglomerated material, the single crystal material with the same nickel content has better cycle life and lower gas production performance. Therefore, the incorporation of single crystal material can effectively improve the properties of the blended materials, such as cycle life and gas production;
2) Due to its special single crystal morphology, the single crystal material has a lower capacity per gram than that of the agglomerated material with the same nickel content. Therefore, the present invention adopts the single crystal material with a slightly higher nickel content to make up for its shortcoming of low capacity per gram. At the same time, its properties such as cycle life and gas production are maintained at the same level as the agglomerated material with a lower nickel content;
3) The blended small particle single crystal material can enter the voids between the large agglomerated particles, exert synergistic effects of mutual supporting and filling together with the large agglomerated particles, and thereby effectively improve the compaction density of the material; and
4) The problems in single crystal materials, such as poor fluidity, difficulty in screening and pulping, can be effectively overcome by adding a small amount of large agglomerated spherical particles in a system mainly comprising small single crystal particles.

Although specific embodiments have been described, these embodiments have been presented by way of example only and are not intended to limit the scope of the invention. The appended claims and their equivalents are intended to cover all modifications, substitutions, and alterations that fall within the scope and spirit of the invention.

1. A cathode active material for lithium secondary battery, characterized in that the cathode active material comprises agglomerated particles represented by Formula A1 and single crystal particles represented by Formula A2
Li₁₊ₐ₁Niₓ₁Co_{y1}M_{z1}M′_{1-x1-y1-z1}O₂ A1
Li₁₊ₐ₂Niₓ₂Co_{y2}M_{z2}M′_{1-x2-y2-z2}O₂ A2
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W,
−0.03≤a1≤0.20, preferably −0.01≤a1≤0.14, more preferably 0≤a1≤0.10, and particularly preferably 0.01≤a1≤0.08,
0.30≤x1≤0.99, preferably 0.57≤x1≤0.99, more preferably 0.72≤x1≤0.99, and particularly preferably 0.80≤x1≤0.99,
0≤y1≤0.30, preferably 0≤y1≤0.21, more preferably 0≤y1≤0.15, and particularly preferably 0≤y1≤0.10,
0≤z1≤0.30, preferably 0≤z1≤0.18, more preferably 0≤z1≤0.11, and particularly preferably 0≤z1≤0.06,
0≤1−x1−y1−z1≤0.10, preferably 0≤1−x1−y1−z1≤0.08, more preferably 0≤1−x1−y1−z1≤0.05, and particularly preferably 0≤1−x1−y1−z1≤0.03,
−0.03≤a2≤0.20, preferably −0.02≤a2≤0.16, more preferably 0.01≤a2≤0.14, and particularly preferably 0≤a2≤0.08,
0.31≤x2≤1.00, preferably 0.59≤x2≤0.995, more preferably 0.75≤x2≤0.995, and particularly preferably 0.81≤x2≤0.995,
0≤y2≤0.30, preferably 0≤y2≤0.21, more preferably 0≤y2≤0.15, and particularly preferably 0≤y2≤0.10,
0≤z2≤0.30, preferably 0≤z2≤0.18, more preferably 0≤z2≤0.11, and particularly preferably 0≤z2≤0.08,
0≤1−x2−y2−z2≤0.10, preferably 0≤1−x2−y2−z2≤0.08, more preferably 0≤1−x2−y2−z2≤0.05, and particularly preferably 0≤1−x2−y2−z2≤0.03,
with the proviso that:
0<x2−x1≤0.5, preferably 0.01≤x2−x1≤0.27, more preferably 0.01≤x2−x1≤0.2, further preferably 0.015≤x2−x1≤0.20, and particularly preferably 0.02≤x2−x1≤0.15, and
preferably a2>a1, more preferably 0.01≤a2−a1≤0.20, particularly preferably 0.01≤a2−a1≤0.12, especially preferably 0.01≤a2−a1≤0.07, and most preferably 0.01≤a2−a1≤0.04.

2. The cathode active material according to claim 1, characterized in that
the agglomerated particles have a particle size D₅₀ of 6 to 30 μm, preferably 8 to 25 μm, more preferably 9 to 20 μm, and particularly preferably 10 to 18 μm, and
the single crystal particles have a particle size D₅₀ of 0.1 to 10 μm, preferably 0.5 to 8.0 μm, more preferably 1.0 to 6.0 μm, and particularly preferably 1.5 to 4.5 μm.

3. The cathode active material according to claim 1, characterized in that
the agglomerated particles are present in an amount of 20 to 90%, preferably 45 to 85%, more preferably 50 to 80%, and particularly preferably 60 to 80%, based on the weight of the cathode active material, and
the single crystal particles are present in an amount of 10 to 80%, preferably 10 to 70%, more preferably 15 to 60%, and particularly preferably 20 to 40%, based on the weight of the cathode active material.

4. The cathode active material according to claim 1, characterized in that
the agglomerated particles have a coating layer containing at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, wherein the coating element is present in an amount of 0.1 to 2 mol %, and preferably about 1 mol %, based on the agglomerated particles, and/or
the single crystal particles have a coating layer containing at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, wherein the coating element is present in an amount of 0.1 to 2 mol %, and preferably about 1 mol %, based on the single crystal particles,
wherein the coating element contained in the coating layer of the agglomerated particles is different from the coating element contained in the coating layer of the single crystal particles.

5. The cathode active material according to claim 1, characterized in that:
the cathode active material has specific surface areas BET_{before} and BET_{after} before and after sintering at 600° C. in an air atmosphere for 8 hours, which satisfy:

|BET_{after}−BET_{before}|/BET_{before}≤50%, preferably, |BET_{after}−BET_{before}|/BET_{before}≤30%,
the agglomerated particles have specific surface areas BET_{before} and BET_{after} before and after sintering at 600° C. in an air atmosphere for 8 hours, which satisfy:
(BET_{after}−BET_{before})/BET_{before}≥15%, preferably, 40%≥(BET_{after}−BET_{before})/BET_{before}≥20%,
the single crystal particles have specific surface areas BET_{before} and BET_{after} before and after sintering at 600° C. in an air atmosphere for 8 hours, which satisfy:
(BET_{before}−BET_{after})/BET_{before}≤15%, preferably, 0≤(BET_{before}−BET_{after})/BET_{before}≤10%.

6. A method for preparing a cathode active material, including the steps of:
i) preparing an agglomerated particle precursor represented by Formula A3 and a single crystal particle precursor represented by Formula A4 separately by a liquid-phase co-precipitation process
Niₓ₁Co_{y1}M_{z1}M′_{1-x1-y1-z1}(OH)₂ A3
Niₓ₂Co_{y2}M_{z2}M′_{1-x2-y2-z2}(OH)₂ A4
wherein
M is one or two elements selected from Mn and Al,
M′ is one or more elements selected from B, F, Mg, Si, P, Ca, Ti, V, Cr, Fe, Ga, Sr, Y, Zr, Nb, Mo, Sn, Ba, La, Ce, and W,
0.30≤x1≤0.99, preferably 0.57≤x1≤0.99, more preferably 0.72≤x1≤0.99, and particularly preferably 0.80≤x1≤0.99,
0≤y1≤0.30, preferably 0≤y1≤0.21, more preferably 0≤y1≤0.15, and particularly preferably 0≤y1≤0.10,
0≤z1≤0.30, preferably 0≤z1≤0.18, more preferably 0≤z1≤0.11, and particularly preferably 0≤z1≤0.06,
0≤1−x1−y1−z1≤0.10, preferably 0≤1−x1−y1−z1≤0.08, more preferably 0≤1−x1−y1−z1≤0.05, and particularly preferably 0≤1−x1−y1−z1≤0.03,
0.31≤x2≤1.00, preferably 0.59≤x2≤0.995, more preferably 0.75≤x2≤0.995, and particularly preferably 0.81≤x2≤0.995,
0≤y2≤0.30, preferably 0≤y2≤0.21, more preferably 0≤y2≤0.15, and particularly preferably 0≤y2≤0.10,
0≤z2≤0.30, preferably 0≤z2≤0.18, more preferably 0≤z2≤0.11, and particularly preferably 0≤z2≤0.08,
0≤1−x2−y2−z2≤0.10, preferably 0≤1−x2−y2−z2≤0.08, more preferably 0≤1−x2−y2−z2≤0.05, and particularly preferably 0≤1−x2−y2−z2≤0.03,
with the proviso that: 0<x2−x1≤0.5, preferably 0.01≤x2−x1≤0.27, more preferably 0.01≤x2−x1≤0.20, further preferably 0.015≤x2−x1≤0.20, and particularly preferably 0.02≤x2−x1≤0.15;
ii) mixing a lithium source with the agglomerated particle precursor at a molar ratio of r1, and optionally incorporating M′ as a doping element, wherein 0.97≤r1≤1.20, preferably 0.99≤r1≤1.14, more preferably 1.00≤r1≤1.10, and particularly preferably 1.01≤r1≤1.08; then performing a primary sintering at the sintering temperature T1 in a sintering atmosphere of air or oxygen, preferably oxygen, wherein 600° C.≤T1≤1000° C., preferably 675° C.≤T1≤875° C., more preferably 690° C.≤T1≤800° C., and particularly preferably 690° C.≤T1≤780° C.; and then obtaining agglomerated particles via crushing;
iii) mixing a lithium source with the single crystal particle precursor at a molar ratio of r2, and optionally incorporating M′ as a doping element, wherein 0.97≤r2≤1.20, preferably 0.98≤r2≤1.16, more preferably 0.99≤r2≤1.14, and particularly preferably 1.00≤r2≤1.08; then performing a primary sintering at the sintering temperature T2 in a sintering atmosphere of air or oxygen, preferably oxygen, wherein 650° C.≤T2≤1050° C., preferably 730° C.≤T2≤930° C., more preferably 750° C.≤T2≤930° C., and particularly preferably 750° C.≤T2≤900° C.; and then obtaining single crystal particles via crushing; and
iv) blending the agglomerated particles of Step ii) with the single crystal particles of Step iii) to obtain the cathode active material,
wherein preferably r2>r1, more preferably 0.01≤r2−r1≤0.20, particularly preferably 0.01≤r2−r1≤0.12, especially preferably 0.01≤r2−r1≤0.07, and most preferably 0.01≤r2−r1≤0.04.

7. The method according to claim 6, characterized in that
the agglomerated particle precursor has a particle size D₅₀ of 6.5 to 30.5 μm, preferably 8.5 to 25.5 μm, more preferably 9.5 to 20.5 μm, and particularly preferably 10.5 to 18.5 μm,
the agglomerated particles have a particle size D₅₀ of 6 to 30 μm, preferably 8 to 25 μm, more preferably 9 to 20 μm, and particularly preferably 10 to 18 μm,
the single crystal particle precursor has a particle size D₅₀ of 0.1 to 30.5 μm, preferably 1.0 to 17.3 μm, more preferably 1.0 to 9.3 μm, and particularly preferably 1.0 to 6.0 μm, and
the single crystal particles have a particle size D₅₀ of 0.1 to 10 μm, preferably 0.5 to 8.0 μm, more preferably 1.0 to 6.0 μm, and particularly preferably 1.5 to 4.5 μm.

8. The method according to claim 6, characterized in that
the agglomerated particles are present in an amount of 20 to 90%, preferably 45 to 85%, more preferably 50 to 80%, and particularly preferably 60 to 80%, based on the weight of the cathode active material, and
the single crystal particles are present in an amount of 10 to 80%, preferably 10 to 70%, more preferably 15 to 60%, and particularly preferably 20 to 40%, based on the weight of the cathode active material.

9. The method according to claim 6, characterized in that, prior to Step iv),
the agglomerated particles are mixed with a coating precursor comprising at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, and then a secondary sintering is performed at the sintering temperature T3 in a sintering atmosphere of air or oxygen, preferably oxygen, to obtain secondarily sintered agglomerated particles, wherein 250° C.≤T3≤800° C., preferably 250° C.≤T3≤600° C., more preferably 250° C.≤T3≤480° C., and particularly preferably 250° C.≤T3≤400° C., wherein the coating element is present in an amount of 0.1 to 2 mol %, and preferably about 1 mol %, based on the agglomerated particles, and/or
the single crystal particles are mixed with a coating precursor comprising at least one coating element selected from the group consisting of: B, F, Mg, Al, Si, P, Ca, Ti, V, Cr, Fe, Ga, Sr, Y, Zr, Nb, Mo, Sn, Ba, La, Ce, and W, and then a secondary sintering is performed at the sintering temperature T4 in a sintering atmosphere of air or oxygen, preferably oxygen, to obtain secondarily sintered single crystal particles, wherein 300° C.≤T4≤900° C., preferably 460° C.≤T4≤800° C., more preferably 550° C.≤T4≤750° C., and particularly preferably 600° C.≤T4≤750° C., wherein the coating element is present in an amount of 0.1 to 2 mol %, preferably about 1 mol %, based on the single crystal particles,
wherein the coating element contained in the coating precursor of the agglomerated particles is different from the coating element contained in the coating precursor of the single crystal particles.
